(19) United States
(12) Patent Application Publication
(10) Pub. No.: US 2004/0047231 A1
(43) Pub. Date: Mar. 11, 2004

(54) Mixing structures

(76) Inventor: Jose V. Coll, Maracay (VE)

Correspondence Address: Richard C. Litman, LITMAN LAW OFFICES, LTD., P.O. Box 15035, Arlington, VA, 22215, US

(21) Appl. No.: 10/639,529

(22) Filed: Aug. 13, 2003

Related U.S. Application Data
(60) Provisional application No. 60/409,591, filed on Sep. 11, 2002.

(51) Int. Cl. B01F 13/00

(52) U.S. Cl. 366/130; 366/342

(57) ABSTRACT

An apparatus and method is provided for mixing a heterogeneous combination to form a homogeneous combination. The apparatus comprises a container and a mixing device located in the container. The container has an inner surface defining an inner volume capable of holding a quantity of liquid and powder. In one embodiment the mixing device has a surface, wherein the surface defines a plurality of apertures; the plurality of apertures define a grill through which the liquid and powder can pass through and thereby mix together. In another embodiment the mixing device defines a multiple number of strands of stainless steel through which the liquid and powder can pass through and thereby mix together. In a further embodiment a method is provided for mixing a powder and liquid combination comprising the step of shaking the container to induce the liquid and powder to pass through the grill.

### CROSS-REFERENCE TO RELATED APPLICATION

This application claims the benefit of U.S. Provisional Patent Application Serial No. 60/409,591, filed Sep. 11, 2002.

### 1. FIELD OF THE INVENTION

The present invention relates to mixing a heterogeneous combination, such as a powder and liquid combination, and more particularly to fixed and movable agitator structures for mixing, for example, a powdered baby formula and water combination.

### 2. DESCRIPTION OF RELATED ART

The preparation of baby food typically comprises the steps of boiling water to provide boiled water, allowing the boiled water to cool to a warm temperature, pouring the warm water into a nursing bottle, and adding an amount of powdered baby formula to the warm water in the bottle. The bottle is then sealed and hand shaken to mix the water and baby formula to provide a mixture of water and baby formula. While this technique is simple, it is well known that baby formula often clumps, forming grume when shaken in warm water.

The typical nursing bottle has a mouth end fitted with a nipple. Grume present in the feed can block-up the nipple. A baby sucking on a blocked nipple may become frustrated and cry.

Mothers or caregivers often try to prevent grume (formula clumping) by vigorously shaking and inverting the bottle. Such vigorous mixing increases the possibility of leakage of the bottle contents.

What is needed is a container with an effective agitator structure, either movable or fixed, which, when the container is shaken, produces a grume-free mixture from two or more heterogeneous substances, e.g., baby formula and milk or water.

The relevant art is as follows.

U.S. Pat. No. 4,818,114, issued Apr. 4, 1989 to M. M. Ghavi, shows a shaker device secured within the top of a baby or nursing bottle for facilitating the mixing of powdered baby formula with water. The shaker device is a mixing disc with a plurality of uniformly spaced arms radiating from a center post. The arms are tapered at each end and are specially manufactured to be diamond shaped. The requirement of a mixing disc of such complex design adds to manufacturing cost, and the complexity of the mixing disc lends itself to the possibility of disc fracture or breakage.

U.S. Pat. No. 5,788,369, issued Aug. 4, 1998 to Wen-Pin Tseng, shows a nursing bottle with a mixing element comprising a fastening ring attached to a securing means of an affixing ring. The mixing element further comprises a plurality of members referred to as stirring ribs. The mixing element is permanently affixed in a location near the nipple and mouth of the nursing bottle; more specifically, the disclosed mixing element is unable to move in different directions inside the nursing bottle. Considerable effort must be expended in order to ensure adequate mixing of the contents of the nursing bottle. Thus, there is a need for a mixing device that can move freely inside the nursing bottle.

U.S. Pat. No. 5,246,670, issued Sep. 21, 1993 to Haber et al, shows a pharmaceutical mixing container comprising a housing defining an inner volume in which a buoyant member is located. A pharmaceutical compound and a liquid are placed in the inner volume, and by manually translating and rotating the housing the buoyant member is said to provide thorough admixing of the pharmaceutical and the liquid combination. The buoyant member is required to have a specific gravity of less than that of the liquid in which the member is placed. Thus, there is a need for a simpler mixing device which is suitable for use in a nursing bottle and does not wholly rely on buoyancy to achieve mixing of a solid and a liquid combination.

U.S. Pat. No. D451,200 S, issued Nov. 27, 2001 to Johansen et al., shows an ornamental design for a mixing device in the form of a mixing ring. The mixing ring is inserted proximate to the mouth of a nursing bottle. Considerable effort would have to be expended to adequately mix baby formula and water placed in the nursing bottle. Thus, there remains a need for a mixing element or device that can achieve good mixing without vigorous human effort.

U.S. Pat. No. 5,547,275, issued Aug. 20, 1996 to Lillelund et al., shows a shaker vessel with an enlarged mouth at the top of the shaker. The shaker incorporates a mixing device referred to as a blender insert which is seated within the enlarged mouth. The '275 patent does not address the problem inherent in using a mixing device that is located proximate to the top of the container.

U.S. Pat. No. 6,332,704, issued Dec. 25, 2001 to Gasser et al. goes someway towards solving the problem inherent in using a mixing device that is located close to the top of the vessel. However, the '704 patent describes a mixing device in the form of a permeable separation sifter which defines two volumes inside the vessel in a ratio of about 2:1. The requirement of a 2:1 ratio is burdensome and imposes stringent requirements on the design of nursing bottles.

Other patents showing devices or apparatus for mixing powders with a liquid but which do not solve the above mentioned problems include Great Britain Patent No. GB 2 045 629-A published Nov. 5, 1980 to C. C. Clarke, and U.S. Pat. No. 5,634,714 issued Jun. 3, 1997 to W. Guild; U.S. Pat. No. 5,692,644 issued Dec. 2, 1997 to Jean-Louis Gueret; U.S. Pat. No. 5,863,126 issued Jan. 26, 1999 to W. Guild; U.S. Pat. No. 6,036,005 issued Mar. 14, 2000 to Krause et al; U.S. Pat. No. 6,059,443 issued May 9, 2000 to T. Casey; and U.S. Pat. No. 6,257,428, issued Jul. 10, 2001 to J. P. Caola.

None of the above inventions and patents, taken either singularly or in combination, is seen to describe the instant invention as claimed. Thus, a mixing device solving the aforementioned problems is desired.

### SUMMARY OF THE INVENTION

The invention is an apparatus and method for mixing a heterogeneous combination, such as a powder and liquid combination, and in one application or embodiment, to an apparatus and method for mixing a powdered baby formula and liquid water combination in a nursing bottle.

The apparatus comprises a container and a mixing device located in the container. The container has an inner surface defining an inner volume capable of holding a quantity of liquid and powder. The mixing device comprises a surface penetrated with a plurality of apertures defining a grill through which the liquid and powder can pass through and thereby mix together.

A method of mixing a liquid and a powder in a container is also provided and comprises the steps of: providing a container with an inner surface defining an inner volume, providing a mixing device comprising a grill located within the inner volume, providing a heterogeneous combination of preselected liquid and powder inside the inner volume, and applying motion to the container in such a manner that the liquid and powder is induced to pass through the grill to provide a homogenous mixture without clump formation.

In the preferred embodiment the container is a nursing bottle and the liquid and powder are water and baby formula, respectively.

Accordingly, it is a principal aspect of the invention to provide a mixing device of simple construction to mix a powder with a liquid.

It is another aspect of the invention to provide an apparatus comprising a mixing device for mixing a selected powder and liquid wherein it is not required that the mixing device has a lower specific gravity than that of the selected liquid.

It is a further aspect of the invention to provide a mixing device the operation of which does not require the subdivision of a container in which the mixing device is placed in the ration of 2:1.

Still another aspect of the invention is to provide a mixing device which achieves mixing between a powder and a liquid in a container, such as a nursing bottle, having a mouth end without the requirement that the mixing device be attached to or in close proximity to the mouth of the nursing bottle.

A further aspect of this invention is to provide a process in which a powder and liquid combination are mixed together.

It is a still further aspect of the invention to provide improved elements and arrangements thereof in an apparatus for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental, perspective view of a mixing system according to one aspect of the present invention.

FIG. 2 is a perspective view of a mixing system according to another aspect of the invention.

FIG. 3 is a perspective view of a spherical mixing device according to one aspect of the invention.

FIG. 4 is a perspective view of a mixing system with a basket mixing device according to the present invention.

FIG. 5 is a top perspective view of a container with an alternative basket mixing device according to the present invention.

FIG. 6 is a perspective view of a mixing system with a conical basket mixing device according to the present invention.

FIG. 7 is a perspective view of a mixing system with a doll shaped mixing device according to the present invention.

FIG. 8 is a perspective view of a mixing system with another basket mixing device according to the present invention.

FIG. 9 is a perspective view including a liquid and powder combination inside the inner volume according to an aspect of the invention.

FIG. 10 is a perspective view of the invention shown in FIG. 9, but with the container inverted according to the present invention.

FIG. 11 is a perspective view of a deep milk mixer according to an aspect of the invention.

FIG. 12 shows an alternative embodiment of a mixing device according to the invention.

FIG. 13 shows a further embodiment of a mixing device according to the invention.

Similar reference characters denote corresponding features consistently throughout the attached drawings.

### DETAILED DESCRIPTION OF THE PREFERRED EMBODIMENTS

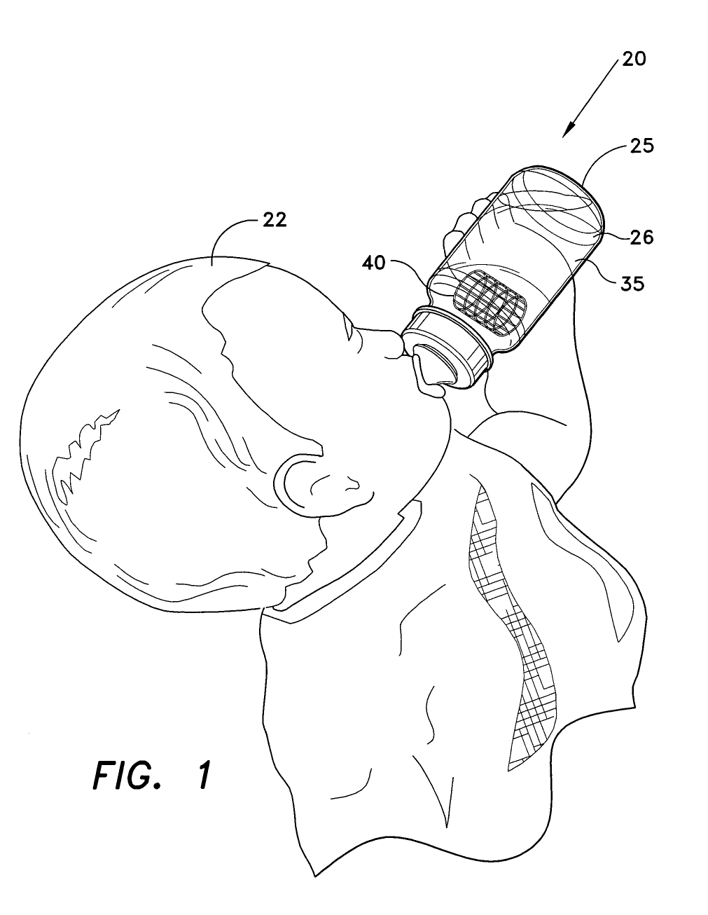

FIG. 1 is an environmental perspective view of the apparatus 20 being used to feed a baby 22 according to one aspect of the present invention. In this embodiment the apparatus of the invention comprises a container in the form of a nursing bottle 25 filled with baby feed in the form of a homogenous solution 26 comprising a clump free mix of water 30 and baby formula. The bottle 25 includes a mixing device 40.

FIG. 2 shows the apparatus prior to use. A container in the form of a nursing bottle 25 comprises an inner surface 45 defining an inner volume 50. The inner volume 50 holds a preselected liquid and powder combination (to be mixed, hence present as a heterogeneous mixture), shown here as water 30 and baby formula 35, respectively. A mixing device 40a is located within the inner volume 50, the device 40a having a specific gravity different from the liquid 30 and having a surface 42 comprising a plurality of apertures 55 defining a grill 60 through which the water 30 and baby formula 35 can pass upon application of motion to container 25, the passage of the water 30 and baby formula 35 through the grill 60 causing the baby formula 35 to mix with the water 30 to provide a homogenous solution 26 as shown in FIG. 1. The device 40a is free to move in any direction inside the inner volume 50.

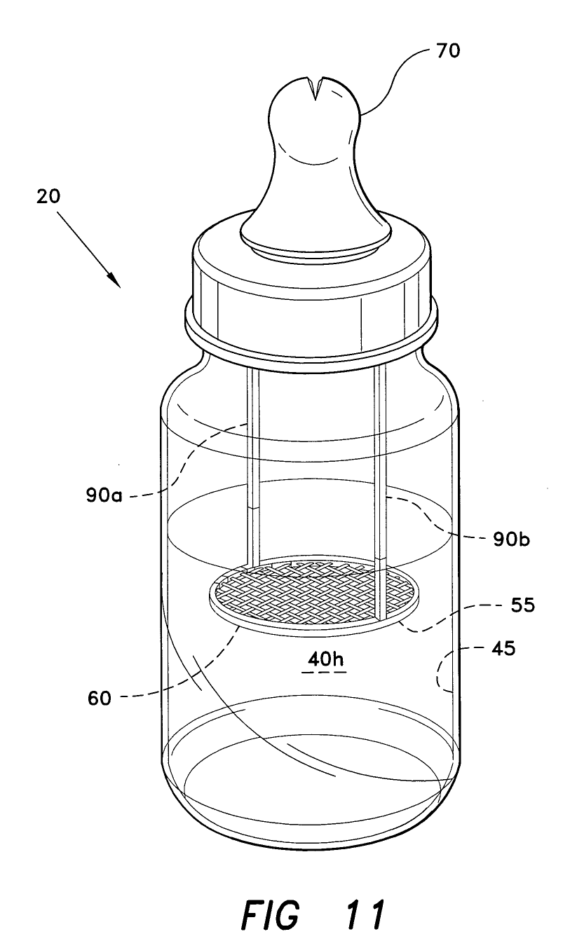

It should be understood that the mixing device 40 might be a movable agitator as described or, in the alternative, a fixed mixing device 40h. For example, device 40a could be affixed to the container 25 and the container 25, containing a heterogeneous mixture to be mixed, inverted to drive the heterogeneous mixture through the apertures of device 40h to provide a homogenous mixture as desired. In another embodiment the fixed mixing device 40h is affixed to the container 25 as shown in FIG. 11.

The mixing device 40 converts a heterogeneous mixture into a homogeneous mixture with mild agitation of the container 25 thereby avoiding the formation of undesirable gas bubbles or micro-gas bubbles so that less gas is swallowed by, for example, a baby. The apparatus 20 is less likely to produce colic in a baby thereby making the mixing device 40 an anti-colic mixing device 40 and the apparatus 20 an anti-colic mixer.

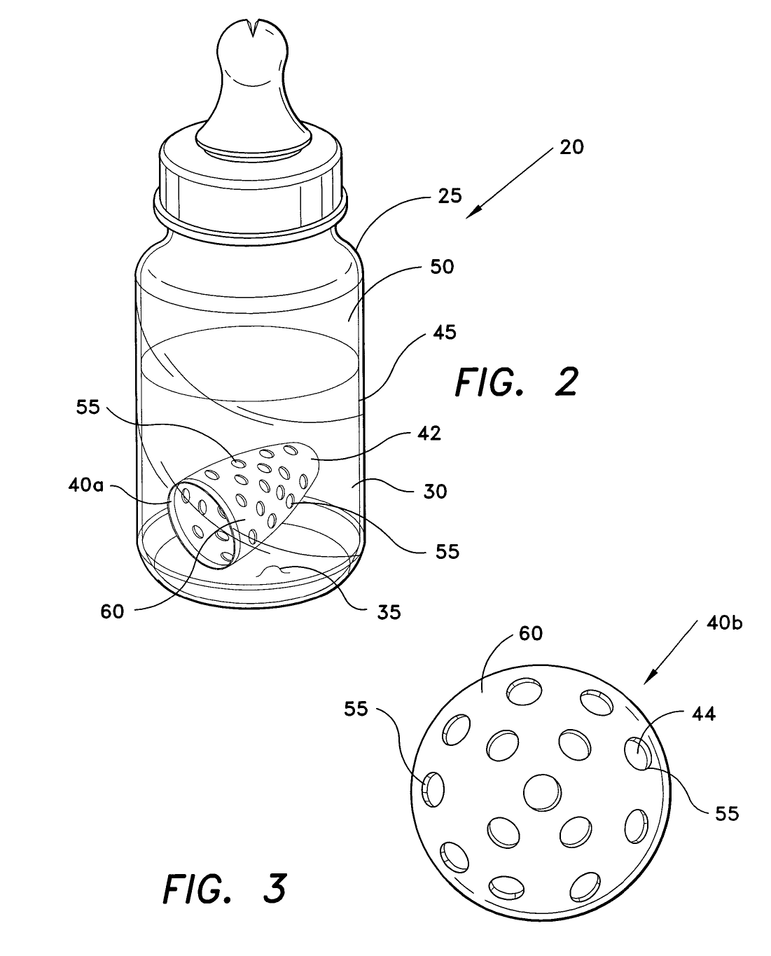

Referring to FIG. 3, the grill 60 comprises a plurality of apertures 55 which can be regular or uniform in size, shape and distribution. Conversely, the apertures 55 could be irregular in size, shape and distribution (not shown). The overall form of the mixing device 40b is that of a spherical grill 60 akin to a golf ball full of holes and lacking a solid inner core layer. In this aspect of the invention the surface 42 of the mixing device 40 defines an inner volume 44 visible through the apertures 55.

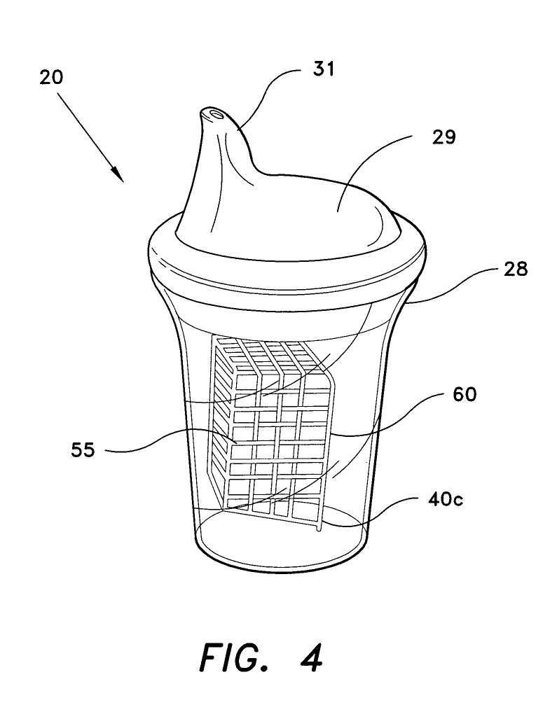

FIG. 4 shows a perspective view of an alternative mixing device 40c inside a baby's drinking cup 28 with a snap on top 29 comprising a spout 31. The overall form of the mixing device 40c is that of a basket comprising an array of apertures 55 defining grill 60.

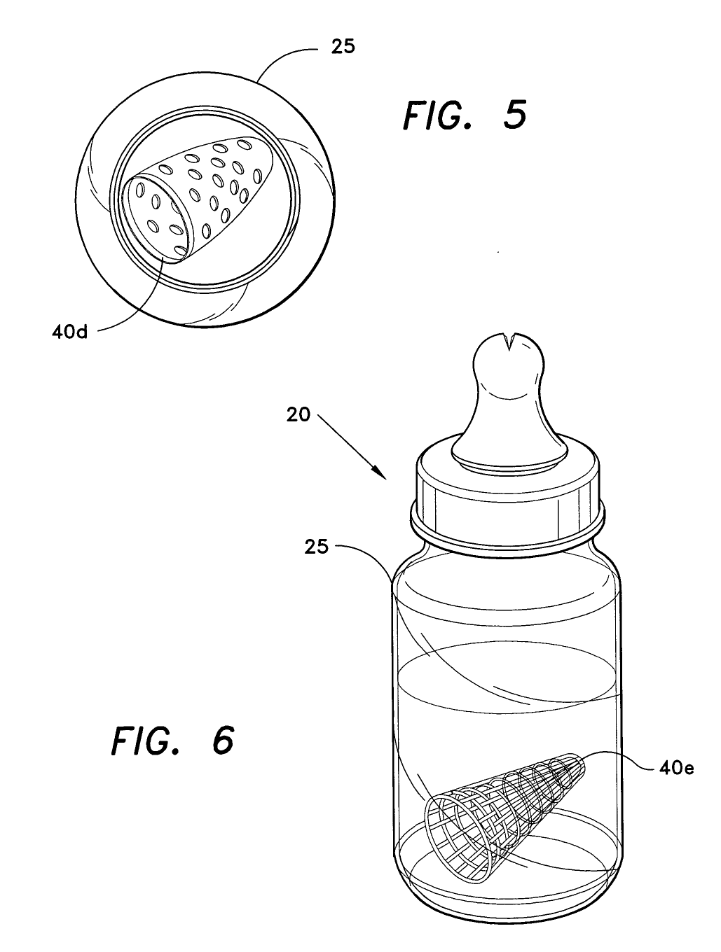

FIG. 5 shows a top perspective view of another embodiment of the invention 20 in which the top of nursing bottle 25 is shown removed. The nursing bottle 25 includes the mixing device 40d in the form of an oval shaped grill 60.

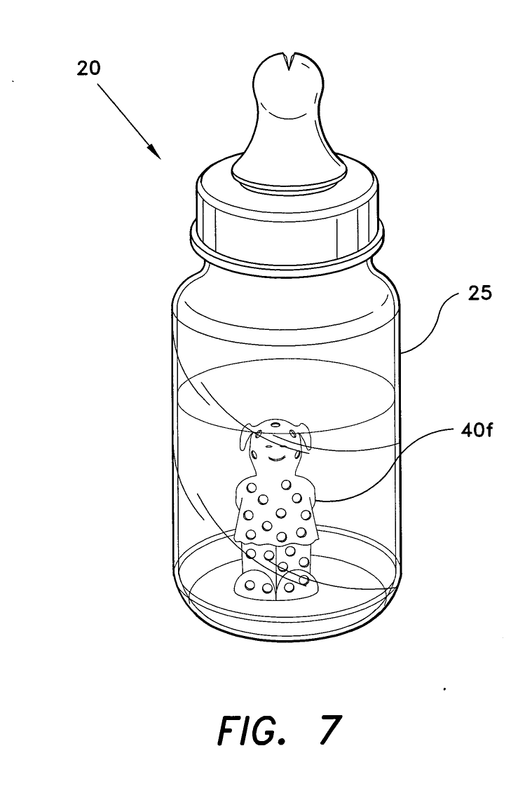

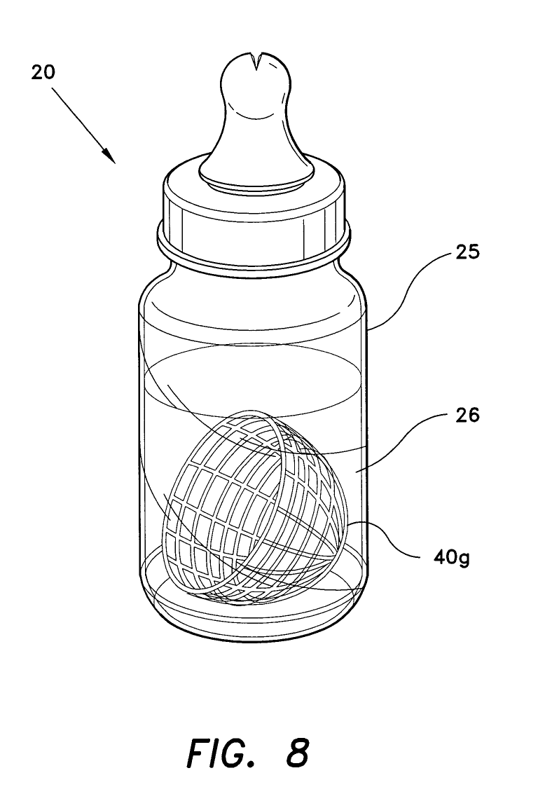

Referring to FIGS. 6, 7, and 8 which show a range of nursing bottles 25 each with a different form of mixing device 40 (40e, 40f, and 40g). Mixing device 40e is in the form of a cone shaped grill 60a. Mixing device 40f is in the form of a doll shaped grill 60b. Mixing device 40g is in the form of a bowl shaped grill 60c.

The apparatus 20 of the invention can be applied to mixing various heterogeneous mixtures that comprise of different ingredients such as: powdered drinks, isotonic compounds, nutritional compositions, juice concentrates, syrups, instant formula, powdered milk, pharmaceutical compositions, cement powders to make concrete homogeneous mixtures.

In the nursing bottle embodiment of the invention it is important that the mixing device is made of nontoxic material, such as a nontoxic polymer or nontoxic polymer combination well known by those skilled in the design of nursing bottles. The chosen material should not be capable of easily breaking the container, such as nursing bottle 25. It should be further understood that the device can be used with any type of nursing bottle, including the sort with an interior, flexible bag (e.g., the Playtex™ nursing bottle).

For applications including industrial applications, the mixing device can be built of a metal or alloy, carbon or epoxy compound and may be used to mix a first powder and a second powder combination or a plurality of powders, a first liquid and a second liquid combination, or a plurality of different liquids, or as described above a heterogeneous powder and liquid combination. The mixing device material should preferably have a different specific gravity from that of at least one of the substances to be mixed.

If the mixing device is used to mix powders (i.e., a powder combination) then the mixing device should have a specific gravity different from at least one of the powders to be mixed and preferably different from the specific gravity of the powder which is present in greatest amount in the powder combination to be mixed. If the powder combination consists of different powders present in about equal amounts by weight or volume, then the mixing device should preferably have a different specific gravity from at least one of the powders, and more preferably a different specific gravity from all of the powders.

Preferably the mixing device has a specific gravity greater than the liquid component of a powder and liquid heterogeneous combination.

The mixing device is dimensioned and configured to fit inside a container such as nursing bottle 25. The mixing device should also be sized so that it is free to move in any direction inside inner volume 50. when bottle 25 is subjected to motion such as translational (e.g., up and down motion), simple inversion, rotational motion or a combination of motions applied to the bottle 25 to drive the liquid and powder combination through the apertures 55 of grill 60 to induce mixing between the liquid and powder.

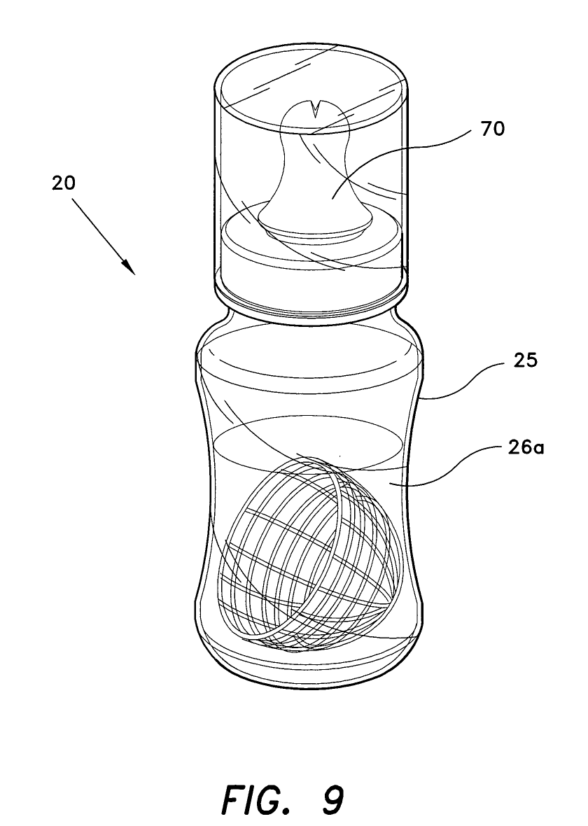

Referring to FIG. 9, which shows a homogeneous, grume-free (i.e., clump-free) solution 26a produced by mixing system 20 after motion was applied to the container 25, thereby inducing the heterogeneous combination of baby powder formula 35 and water 30 to travel through apertures 55 of mixing device to provide the clump free solution 26 suitable for feeding to a baby via nipple 70. The application of motion to the bottle can take any suitable form such as a translational or rotational motion, or combinations thereof, and may include shaking motions as well as inverting the container 25.

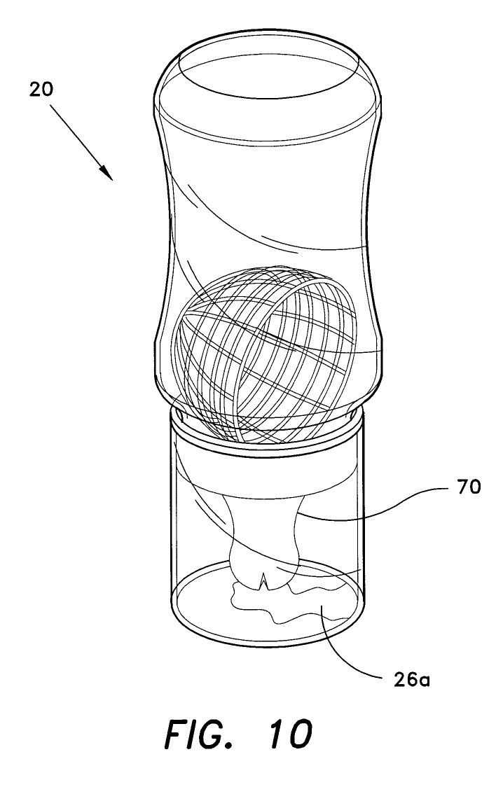

FIG. 10 shows the homogeneous solution 26 is able to flow through nipple 70 by inverting the bottle 25 and allowing mere gravity to drive the homogeneous solution 26 to flow out of the bottle 25 via nipple 70 into a cup 27.

In another aspect of the invention a process of mixing a liquid and a powder in a container 25 is provided, comprising the steps of: providing a container 25 with an inner surface 45 defining an inner volume 50, providing a mixing device 40 located within the inner volume 50, providing a combination of preselected liquid and powder inside the inner volume 50, and applying movement to the container 25, wherein the mixing device 40 has a specific gravity different from that of the liquid, and further wherein the mixing device has a surface 42 comprising a plurality of apertures 55 defining a grill 60 through which the liquid and powder can pass, wherein the passage of the liquid and powder through the apertures 55 of grill 60 causes the powder to mix with the liquid to provide a clump free homogeneous solution, wherein the device 40 is free to move in any direction inside inner volume 50.

In another embodiment the fixed mixing device 40h is affixed to the container 25 as shown in FIG. 11. In this embodiment, the mixing device 40 (shown as 40h) further comprises connecting arms 90a and 90b, which fix the position of grill 60 within container 25; different types of grills may be used and may further include apertures 55 of varying size and shape. The number of connecting arms 90 might vary, but at least one connecting arm is required to affix the grill 60 with respect to the container 25.

Still referring to FIG. 11, the grill 60 is located in the bottom half of the container 25 to provide a deep milk mixer, but by varying the length of the connecting arms 90, the grill 60 may be located advantageously at any position within the container 25. In particular, the grill 60 may be position some distance away from the top of the container 25 and therefore solves the problem of locating the mixing device too close to the top of the container. Specifically, less effort is required to mix a heterogeneous mixture with the grill 60 of mixing device 40h is located deeper and away from the top of the container 25. However, if desired, the length of the arms 90 may be shortened to the point that the grill 60 is proximate to the top of the container 25.

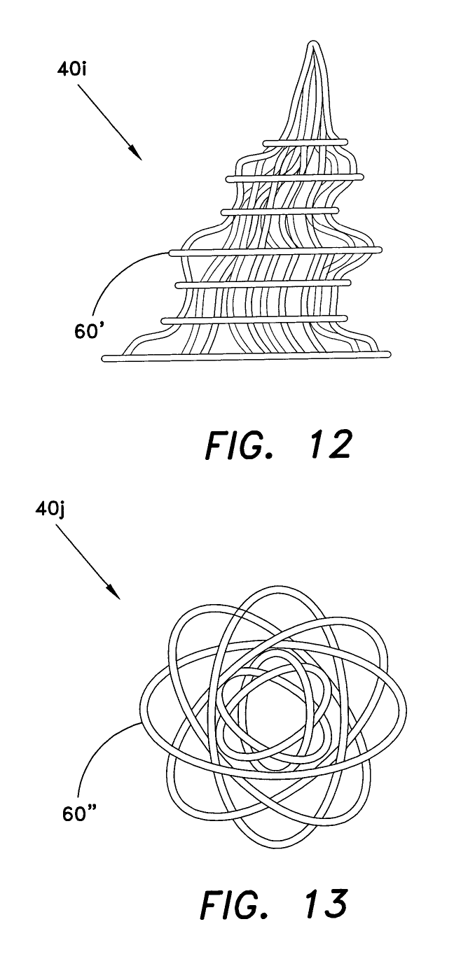

The mixing device 40 can be any shape providing that the mixing device 40 fits comfortably inside the container of the mixing system 20 such as nursing bottle 25. For example, in FIG. 12 the mixing device 40i defines a variable shaped grill 60′. In FIG. 13 the mixing device 40j is essentially a ball of stainless steel that defines the grill 60″ which takes the form of a mesh of stainless steel that defines a plurality of apertures through which a heterogeneous mixture such as water 30 and baby formula 35 can pass upon application of motion to the container 25. The mixing device 40 can be a disposable mixing device.

In any of the various embodiments illustrated and described above, one or more arms (not shown) could be attached to the invention mixing device, to facilitate insertion of the device into the combination to be mixed, and/or to pluck the device from the mixture afterwards. Also, U.S. Provisional Patent Application Serial No. 60/409,591, filed Sep. 11, 2002, is hereby incorporated by reference in its entirety.

Also in any of the embodiments discussed and shown above, the mixing device may be disposable after a single use; the materials chosen to make the device may be sufficiently inexpensive to make this economically feasible.

It is to be understood that the present invention is not limited to the embodiments described above, but encompasses any and all embodiments within the scope of the following claims.

I claim:

1. A mixing system for mixing a powder and liquid combination, comprising:
a container with an inner surface defining an inner volume capable of holding a preselected liquid and powder combination; and
a mixing device located within said inner volume, wherein said device has a specific gravity different from the liquid and having a surface comprising a plurality of apertures defining a grill through which the liquid and powder can pass, the passage of the liquid and powder through the grill causing the powder to mix with the liquid, wherein said device is free to move in any direction inside said inner volume.

2. The mixing system according to claim 1, wherein the mixing device is affixed to the container by at least one connecting arm such that the grill is located approximately in the middle of the container.

3. The mixing system according to claim 1, wherein the container is a nursing bottle, the powder is baby formula, and the liquid is water.

4. The mixing system according to claim 1, wherein the mixing device is a perforated spherical grill.

5. The mixing system according to claim 1, wherein the mixing device defines a ball of stainless steel wire, wherein the wire defines a plurality of apertures.

6. The mixing system according to claim 1, wherein the mixing device is a basket grill.

7. The mixing system according to claim 1, wherein the mixing device is constructed from a plastic polymer.

8. A method of mixing a liquid and powder combination, comprising the steps:
providing a container with an inner surface defining an inner volume;
providing a mixing device located within said inner volume;
providing a liquid and powder combination inside said inner volume; and
applying movement to said container, wherein said mixing device has a specific gravity different from that of the liquid, the mixing device having a surface comprising a plurality of apertures defining a grill through which the liquid and powder combination can pass, wherein the passage of the liquid and powder through the grill causes the powder to mix with the liquid, and wherein said device is free to move in any direction inside said inner volume.

9. The method according to claim 8, wherein the container is a nursing bottle, the powder is baby formula, and the liquid is water.

10. The method according to claim 8, wherein the mixing device is a spherical grill.

11. The method according to claim 8, wherein the mixing device is a basket grill.

12. The method according to claim 8, wherein the mixing device is constructed from a plastic polymer.
